(19) United States
(12) Patent Application Publication
(10) Pub. No.: US 2009/0304867 A1
(43) Pub. Date: Dec. 10, 2009

(54) FRUIT-CONTAINING CHOCOLATE OR THE LIKE

(76) Inventors: Jean-Luc Rabault, Breuillet (FR); Flavien Lambert, Clamart (FR); Eric Dugre, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/515,136

(22) PCT Filed: Nov. 15, 2007
(86) PCT No.: PCT/EP07/62403

§ 371 Date: Jul. 24, 2009

(30) Foreign Application Priority Data
Nov. 16, 2006 (FR) 0610023

(51) Int. Cl. A23G 1/48; A23G 1/00; A23L 1/212; A23G 1/30

(52) U.S. Cl. 426/61; 426/631; 426/285; 426/93

(57) ABSTRACT

The invention relates to a fruit containing chocolate or the like, containing at least one sweetening agent, less than 3 wt % and advantageously less than 1 wt % of dried non fatty cocoa, between 24 and 50 wt % of fatty material, and between 1 and 20 wt % of fruit powder, the fruit powder having a D₉₀ lower than 500 μm and a water content lower than 5 wt %. The invention further relates to a method for producing said chocolate and to the use thereof in food products.

The present invention relates to chocolate or the like flavored with fruit, i.e. having a taste and color of “natural” fruit, not very sticky (unlike jams) fruit, while having a good nutritional composition.

Most fruit-containing chocolate tablets contain large pieces of fruit, most often associated with dry fruit (almonds, hazelnuts) or exclusively fruit flavorings. All these chocolates including fruit portions or fruit flavorings retain a standard aspect of black chocolate or of milk or white chocolate and therefore do not have the natural color of the fruit. Their taste is generally a rather cocoa-like taste and these chocolates therefore do not have the natural taste of fruit.

There also exist white chocolates or chocolate compounds, colored and flavored with fruit. But they are made with coloring additives and flavors, which gives a low end artificial image and poor rendering of the colors and of the fruit flavorings.

French Patent Application FR 2 471 144 describes the making of a chocolate containing fruit powder. However, the water content of the fruit used is rather large (candied or sun-dried fruit with a maximum of 35% by weight of water, or 25% by weight of water. Thus, dry sultanas or dry dates for example contain 19% by weight of water) and/or the kinds of fruit do not have the natural taste of fruit because they are too sweet (candied fruit). It is further indicated in this patent that such fruit contains less water than fresh fruit but still a larger amount of water relatively to chocolate. This is why the method for incorporating these kinds of fruit into chocolate is very complicated. Indeed, it is well known that providing small amounts of water in chocolate causes a very strong increase in viscosity or even bulk setting of the chocolate. Further, the use of candied fruit is complicated because of their stickiness.

The fruit powder seems to be a good candidate for flavoring and coloring chocolates and the like, provided that it only provides very little water. However, even dry, the fruit may pose the following problems:
Increase in viscosity and yield stress, notably related to the fact that the fruit is reduced into a very fine powder during the process and to the fact that the fruit powder is very hygroscopic.
Problem of color stability, notably for high Aw, in particular above 0.88, of the composite medium which will be in contact with the chocolates or the like. On the contrary, coloring additives generally used in white chocolates are insoluble in water, therefore stable in a humid medium.

Now the inventors have surprisingly discovered that it is possible to flavor chocolates by using “natural” fruit powder while providing the chocolate with the natural color of fruit, while retaining good nutritional properties of chocolate (not too much sugar or fat, no artificial additives such as flavoring or coloring agent) and while using a very simple making method, i.e. without the problems of the prior art.

The present invention therefore relates to a chocolate with fruit or the like, comprising at least one sugaring agent, less than 3% by weight of non-fatty dry cocoa based on the total weight of the chocolate or the like, advantageously less than 1% by weight, between 24 and 50% by weight of fat based on the total weight of the chocolate or the like and between 1 and 20% by weight of a fruit powder based on the total weight of the chocolate or the like, the fruit powder having a D₉₀ less than 500 μm and a water content less than 5% by weight based on the total weight of the fruit powder.

In the sense of the present invention, by “chocolate” is meant any concentrated suspension of solid particles in a continuous fatty phase, which is not a water-in-oil emulsion. The definition of chocolate is in particular given by the 2000/36/EC Community Directive. Preferentially the chocolate contains as fat exclusively cocoa butter and/or AMF (Anhydrous Milk Fat) and/or hazelnut oil and/or almond oil and/or emulsifiers. However it may further contain as a mixture with cocoa butter, other fats authorized in the 2000/36/EC Community Directive. The chocolates may have a very crisp texture at 20° C. (for example if they only contain cocoa butter) or a rather soft texture (for example if they contain a larger proportion of AMF or especially hazelnut oil).

In the sense of the present invention, by “chocolate analog” is meant any concentrated suspension of solid particles in a continuous fat phase having a SFC_{20° C.} (Solid Fat Content measured at 20° C.) larger than or equal to 50% and which is not an water-in-oil emulsion, but which does not meet the definition of chocolate. The analog may indeed contain ingredients which, according to the 2000/36/EC Community Directive are not authorized in a chocolate, such as for example starch or certain vegetable fats (FM) (Fatty Materials). This may for example be a hydrogenated optionally fractionated lauric fatty material. The analog may also contain ingredients authorized in chocolate, but at doses which are not accepted for chocolate (for example more than 5% of vegetable fats other than cocoa butter). These analogs of chocolate are generally called in French “pâte à glacer” and in English “chocolate compound or “compound”

This gives it a texture close to chocolates.

In the remainder of the application, the term “chocolate” encompasses the analogs of chocolate and chocolate itself, unless specified otherwise.

Advantageously, the fat content of chocolate according to the present invention is comprised between 27 and 45% by weight based on the total weight of the chocolate, advantageously between 27 and 38% by weight based on the total weight of the chocolate.

In a particular embodiment, when the chocolate according to the present invention is intended to be in contact with a humid food medium (such as a milk base, yogurt, mousse, etc.) with an Aw larger than 0.88, the fat content of the chocolate according to the present invention is comprised between 32 and 50% by weight based on the total weight of the chocolate, advantageously between 32 and 45% by weight based on the total weight of the chocolate, in an advantageous way between 32 and 38% by weight based on the total weight of the chocolate, still more advantageously between 35 and 38% by weight based on the total weight of the chocolate.

In a particular embodiment, when the chocolate according to the present invention is intended to be in contact with a humid food medium (such as milk base, sugar filling with yogurt, etc.) with an Aw less than or equal to 0.88, advantageously less than or equal to 0.85, the fat content of the chocolate according to the present invention is comprised between 28 and 38% by weight based on the total weight of the chocolate, advantageously between 30 and 35% by weight based on the total weight of the chocolate, in an advantageous way between 30 and 33% by weight based on the total weight of the chocolate.

The fat content is therefore adapted to the Aw of the product in contact with the chocolate according to the present invention, to the storage duration/temperature and to the thickness of the chocolate. Indeed for the uses of chocolate in contact with a humid food medium, notably in the case of coatings of fresh bars (i.e. bars with a humid filling with an Aw of 0.78-0.96, advantageously 0.8-0.93, in an advantageous way 0.88-0.92 and kept in the refrigerator, advantageously between 1 and 10° C., in an advantageous way for a least 10 days, still more advantageously for at least 30 days), the chocolate according to the present invention should also withstand water (no excessive softening or change in color).

Now with a sufficiently high fat (FM) content, the chocolate may retain its crispness and avoid too large migration of the water from the humid food medium to the chocolate. This migration is faster if the thickness of the chocolate is smaller or if the storage temperature is higher.

The nature of the FM will also be adapted in the case of use in a high Aw medium: solid FM (measured by SFC at the storage temperature) is more effective against migration of water than liquid oils. Preferably, FMs of the cocoa butter type or hydrogenated and/or fractionated vegetable FMs will then be used. These water migration phenomena and the resistant formulations are already detailed in the patent applications WO 00/07456 and FR 99 06481.

In the sense of the present invention, by “sugaring agent” is meant any sugar (monosaccharides or disaccharides), glucose and/or fructose syrups, maltodextrins, polyols and intense sweeteners. Among monosaccharides, mention may be made of fructose, galactose, glucose. Among disaccharides, mention may notably be made of saccharose which is the sugar currently used for making chocolate, but saccharose may be partly or totally replaced with another disaccharide such as lactose, for example in an amount from 0 to 50% by weight, or with polyols such as for example mannitol and maltitol. The preferred alternative is however saccharose.

Advantageously, the amount of sugaring agent of the chocolate according to the present invention is comprised between 1 and 55% by weight based on the total weight of the chocolate, more advantageously between 10 and 50% by weight based on the total weight of the chocolate, still more advantageously between 10 and 45% by weight based on the total weight of the chocolate, advantageously between 20 and 40% by weight based on the total weight of the chocolate, more advantageously between 20 and 33% by weight based on the total weight of the chocolate.

In the sense of the present invention, by “fruit” is meant any “natural” fruit excluding fruit with shells (walnuts, hazelnuts, almonds, cashew nut, pecan nut . . . ). Candied fruit is excluded. This is for example red fruit such as strawberries, raspberries, blueberries, or blackberries, exotic fruit such as pineapple, mango or kiwi, melon, peach, apricot, banana, cherries, apples, pears, citrus fruit such as orange, lemon, grapefruit or clementine, grapes, plums, cherry plums, figs. Advantageously, this is red fruit.

In the sense of the present invention, by fruit powder is meant any fruit as defined above, dried and reduced into powder and the water content of which is less than 5% by weight based on the total weight of the fruit powder, more advantageously less than 3.5% by weight based on the total weight of the fruit powder, still more advantageously less than 2% by weight based on the total weight of the fruit powder. The fruit powder is distinguished from fruit pieces by finer grain size. Thus its D₉₀ is <500 μm, advantageously <250 μm, advantageously <120 μm, even more advantageously <60 μm. Fruit purees are also excluded because they contain a water content >5% by weight. Quite obviously, the fruit powder may be obtained by drying the totality of the edible portion, or by drying only one part of the edible portion, for example the juice or the pulp (residue after extracting the juice). Advantageously, the invention will use the totality of the edible part.

D₉₀ is the diameter below which 90% of the volume of all the particles of a powder is found.

Advantageously, the fruit powder is totally dehydrated. Advantageously, the fruit of the powder is in a freeze-dried form which gives a more intense and more natural aromatic note and colors to the final product.

In an advantageous way, the amount of fruit powder of the chocolate according to the present invention is comprised between 2 and 15% by weight based on the total weight of the chocolate, advantageously between 4 and 10% by weight based on the total weight of the chocolate, still more advantageously between 5 and 8% by weight based on the total weight of the chocolate.

In the sense of the present invention, by “fruit equivalent” is meant the dry material (DM) of the applied fruit/DM of the fruit in the natural condition.

For example: natural strawberry has 10% DM and 90% water. Using 5.15% of a strawberry powder with 3% water, i.e. having 97% of fruit DM in a finished product gives a fruit equivalent of (97/10)*5.15%=50%.

Thus, advantageously, the chocolate according to the present invention contains a fruit equivalent above 20%, advantageously above 40% and even above 80%.

With the low or zero non-fatty dry cocoa content of the chocolate according to the present invention, it is possible to avoid brown coloration of the chocolate so that the latter may exclusively be colored by the presence of the fruit powder and in a less advantageous way by means of a coloring agent. The chocolate according to the present invention thus has the natural color of the fruit which flavors it.

Advantageously, the Aw at 25° C. of the chocolate according to the present invention is less than 0.60, preferably less than 0.50 and advantageously less than 0.35.

The activity of the water of a product is a notion which is well known in the food industry field, this quantity, abbreviated as Aw, measures the availability of water in a sample. In most cases, this water activity is not proportional to the water content of the product.

The methods with which the Aw of a product may be measured are known to one skilled in the art. For chocolates and the like, which are relatively impervious to water, the measurement method according to the invention consists in cutting the chocolate powder (in order to expose a large surface area) and of measuring Aw at 25+/−2° C. with a Novasina™, an apparatus which leaves sufficient time (24 h) for balancing water between the sample and the air.

In a particular embodiment, the chocolate according to the present invention further contains between 1 and 40% by weight of dry starch based on the total weight of the chocolate, advantageously between 5 and 30% by weight based on the total weight of the chocolate, in an advantageous way between 13 and 22% by weight based on the total weight of the chocolate.

In the sense of the present invention, by “dry starch” is meant starch which does not contain water and which has therefore been entirely dried. The dry starch according to the present invention is advantageously added as native and/or non-gelatinized overdried starch, optionally thermized for lowering its microbial load.

One skilled in the art is aware of different techniques for recognizing non-gelatinized starch; the simplest one is observing it with a microscope in polarized light: the non-gelatinized grains appear as “Malta crosses” (birefringency), while gelatinized grains lose this characteristic.

It is thus possible within the scope of the present invention to replace a significant portion of the sugars traditionally present in chocolate with native or physically modified starch without altering the sweet flavor of the product. By adding starch, it is thereby possible to substantially reduce the fat content of the chocolate according to the invention.

Unlike sugars, starch is not sweet and does not melt in the mouth and it is therefore surprising that the chocolate according to the invention has similar or even better organoleptic characteristics than conventional products.

Any type of starch may be used, and notably wheat starch, maize starch, waxy corn starch, tapioca starch, rice starch, potato starch or mixtures thereof.

Advantageously, native starch, i.e. non-gelatinized starch, is used and this starch will not be gelatinized during the subsequent process. Unlike syrups of glucose, with maltodextrins and proteins, native starch absorbs very little saliva in the mouth and therefore does not increase the stickiness of the chocolate. Further, as native starch is a non-modified natural product, it is not part of food additives, which have to be reported as such on the package of the marketed product.

Further, native starch does not have any digestive drawbacks, unlike polyols which have a laxative effect, which is particularly undesirable in products which are intended for children. The fact that it is not cooked makes natural starch slowly digestible, which allows a reduction of the glycemic index of the chocolate according to the present invention. Thus, addition of native starch in the chocolate according to the invention causes as an additional effect a sensation of satiety which is extended relatively to conventional chocolates. Further, the density of native starch is high and its granules do not have porosity accessible to fat. This lack of accessible porosity is important in order not to increase the viscosity of the chocolate following inclusion of fat into the pores.

The grain size of granules of native starches, which is generally comprised between 2 μm and 100 μm, and more generally between 5 μm and 45 μm, is also ideal for a use of the chocolate according to the invention. Thus, native starches do not comprise too many fine particles or too many large particles. The presence of fine particles increases the viscosity of the chocolate and therefore requires an increase in the fat content. Conversely, the presence of large particles gives to the chocolate a sandy sensation in the mouth. The balance between small size and large size granules may, if need be, be adjusted according to the sought textures and properties, by mixing in different proportions, starches from various origins.

In an advantageous embodiment, the size of the particles of the starch is for at least 90% of the particles, comprised between 2μm and 100 μm, preferably between 5 μm and 45 μm.

Among native starches, wheat starch is preferred, because it has an ideal grain size from 2 μm to 45 μm, and because it is a natural constituent in cereal cooking products, which are mainly based on wheat flour, moreover often mixed with wheat starch.

Maize and manioc starches are also part of the preferred starches because of their grain size.

Other advantages of native starch are its neutral flavor and its white color, which allows the chocolate according to the present invention to assume the taste and the color of the fruit powder. Finally, native starch is an inexpensive ingredient; and it may often be used without any grinding in the chocolate according to the invention, which allows a simplified making process and larger productivity.

In addition to native starch, overdried starches, i.e. non-cooked starches may also be used according to the invention, for which the humidity content was brought below their relative equilibrium humidity. The use of a mixture of native starches and of overdried starches or of different types of overdried starches may also be contemplated.

Native wheat starch contains about 13% of water and 87% of starch nutrient. In the sense of the invention, one speaks of dry starch in order to avoid any confusion, because dry starch=starch nutrient According to the invention up to 40% by weight of dry starch may therefore be provided, i.e. a native wheat starch content of about 46% by weight.

In certain chocolates according to the invention, the whole or part of the starch may be brought as a non-gelatinized native flour rich in starch, for example a cereal flour, such as wheat, rice, or maize flour. Wheat flour may be assimilated to a mixture of 12% by weight of proteins, of 83% of starch with 13% of water, of 1% of fats and of 4% of fibers. Optionally, this flour may be overdried and/or it may be thermized (in order to lower its microbial load). By thermized flour is meant a flour, which was subject to a heat treatment in order to lower its microbial load, without gelatinizing its starch. Preferably, these non-gelatinized flours are cereal flours.

Starch alone however is the preferred version over the version containing only flour or flour and starch, because this gives products which are a little less sticky in the mouth and a little more neutral in taste.

It was not obvious to be able to use non-overdried starch (or flour) because the starch contains water, generally from 13% to 20% water, which results in that the introduction of 15% of wheat starch (containing 13% of water) in a formulation for example provides about 2% water in the formulation. Now, it is well known that by adding such an amount of water directly in free form, or in the form of a honey or a sugar syrup for example, causes “solidification” of the chocolate, and causes risks of saponification in the presence of lauric FMs notably (very often used in analogs of chocolate). Surprisingly and unexpectedly, none of these problems is encountered during the use according to the invention of a starch or a flour in the chocolate according to the invention.

As indicated earlier, by adding starch in the chocolate according to the invention, it is further possible to reduce the sugar and fat content of the chocolate.

In another embodiment, the chocolate according to the invention further contains milk and/or milk derivative powder at a content comprised between 5 and 40% by weight based on the total weight of the chocolate, advantageously between 10 and 35% by weight based on the total weight of the chocolate, in an advantageous way between 15 and 30% by weight based on the total weight of the chocolate.

In the sense of the present invention, by “dairy derivatives as a powder” is meant any product derived from milk and which appears as a powder (non-limiting examples: milk powder either skimmed or not, lactoserum, lactose, buttermilk, caseinates, concentrates of total or serum proteins . . . ). The AMF provided alone is not included, on the other hand the milk FM provided via whole milk powder is comprised in this definition. By extension, the dry material from the provided milk is also included as a liquid and dried during the method for making the chocolate according to the present invention.

Dairy derivatives provide lactose (sugar), but also interesting nutrients such as proteins and calcium.

Advantageously, the content of (milk powder+powdered milk derivatives+dry starch) of the chocolate according to the invention is larger than 25% by weight based on the total weight of the chocolate, advantageously larger than 35% by weight based on the total weight of the chocolate, in an advantageous way larger than 40% by weight based on the total weight of the chocolate.

With these contents, for nutritional reasons, the amounts of sugaring agent of the chocolate according to the invention may be reduced while providing the “filler agent” function generally provided by the sugars.

Moreover, it is not obvious to strongly increase the milk protein content in the chocolate, notably because of a viscosity/yield stress increase during the storage of liquid (molten FM), and this all the more so since the storage temperature is high and all the more since the water content of the chocolate increases or the EM content decreases. This is well known to one skilled in the art of chocolate-making; whence the benefit of filler agents such as starch or fibers.

It was therefore not obvious to combine both a large amount of milk powder and a significant amount of fruit powder and/or starch. Indeed:
starch provides a large amount of water (but the inventors have discovered that the latter is highly bound, which explains that it does not pose any problem)
in order to entirely retain the color and the flavor of the fruit, it is preferable not to heat the chocolate above 55° C., preferably above 45° C., which limits the possibility of evaporation of the water which normally occurs during conching.
the fruit and milk powders increase the viscosity of the chocolate.

Advantageously, the chocolate according to the invention further contains at least one emulsifier, advantageously selected from lecithin, PGPR (polyglycerol polyricinoleate) or ammonium phosphatide. In a certain range, the viscosity of the chocolate is adjusted by the FM content and/or by adding emulsifiers (well known to one skilled in the art).

Advantageously, the emulsifier is present in an amount <1% by weight based on the total weight of the chocolate according to the invention, advantageously in the case of PGPR, <0.5% by weight based on the total weight of the chocolate according to the invention.

Advantageously, the chocolate according to the invention contains more than 120 mg of elementary calcium for 100 g of chocolate, advantageously more than 400 mg for 100 g of chocolate, and preferably more than 1,000 mg for 100 g of chocolate. The calcium may stem from the milk powder or from dairy derivatives. It is also possible to reinforce the calcium with a calcium concentrate of dairy origin or preferably with non-dairy calcium which may be (non-exhaustively): calcium carbonate or calcium citrate powders. In this case, the chocolate according to the invention contains a calcium source other than milk or dairy derivatives.

In a particular embodiment, no fruit flavor other than the one already naturally present in the fruit powder is added into the chocolate.

Advantageously, the chocolate does riot contain any food additives other than the emulsifiers.

Also advantageously no coloring agent, other than the one naturally present in the fruit powder is added into the chocolate according to the present invention, in particular when the chocolate according to the present invention is intended to be used in contact with a food product with Aw≦0.88, advantageously≦0.85. Advantageously, the chocolate according to the present invention does not contain any coloring agent considered as an additive in European legislation according to the 94/36/EC Directive as of 30.06.94, and bearing a code E.

However, optionally, the color of the chocolate according to the invention may be reinforced with at least one coloring agent. This is in particular the case when the chocolate according to the invention is intended to be used in contact with a food product with Aw>0.88. Indeed, in this case, the color of the fruit may be altered, notably lightened, upon migration of water in the chocolate: at least a large amount of a coloring agent is then further preferably added, advantageously a non-water soluble coloring agent so that it does not migrate towards the humid food product with which the chocolate according to the invention is in contact.

Advantageously, the water content of the chocolate according to the invention, is less than or equal to 6% by weight based on the total weight of the chocolate. Advantageously, the chocolate according to the invention contains less than 1% by weight based on the total weight of the chocolate, of water as droplets, preferably less than 0.2%.

The present invention further relates to a method for making a chocolate according to the invention characterized in that 1 to 20% by weight of fruit powder having a D₉₀ less than 500 μm and a water content less than 5% by weight are added to the chocolate or the like containing the fat, the sugaring agent and possibly non-fatty dry cocoa, the mixing and storage temperature not exceeding 55> C. for more than 30 minutes, advantageously not exceeding 45° C. for more than 30 minutes. Preferably, the whole making process and the storage are at less than 55° C., advantageously at less than 45° C. With this, the color and the flavor of the fruit may be preserved and the aggregates (lumps) which have then to be sieved or ground again, may be limited on the other hand. If the fruit powder is fine enough, it is added after the steps for grinding the other ingredients. Preferably, the fruit powder has water content less than 3.5%, advantageously less than 2%. As the fruit powders are very hygroscopic, precautions should be taken in order to avoid their re-hydration (brief storage before opening, reduced relative humidity of the air . . . ). In another advantageous method for making the chocolate according to the present invention, entire pieces of fruit or large pieces of fruit having the water content of the fruit powder according to the present invention, are added into the chocolate and then ground during the method for making the chocolate according to the invention so as to obtain the desired D₉₀. Advantageously, a portion of the lecithin is added before this grinding.

Advantageously, within the scope of the making method according to the present invention, the fruit used is freeze-dried fruit.

The present invention further relates to the use of the chocolate according to the present invention for totally or partly coating biscuits, patties, candy bars, cereal bars, pastries, ice creams, sherbets, or the like, fresh patties or fresh bars, said fresh patties or fresh bars containing a filling having an Aw comprised between 0.78 and 0.96, preferably between 0.8 and 0.93, advantageously between 0.88 and 0.92.

In the sense of the present invention, by “bars” is meant any “solid” product normally eaten manually (without a spoon), and having the shape of a bar (munched several times).

Advantageously, the filling of fresh patties or fresh bars contain living ferments such as for example Lactobacillus bulgaricus, Streptococcus thermophilus and/or Lactobacillus acidophilus and/or bifidus, preferably provided by a real yogurt or equivalent (and not by directly sowing concentrated ferments). Preferably, said filling of fresh patties or fresh bars containing living ferments have an Aw comprised between 0.87 and 0.96.

Advantageously, the Aw of the filling of fresh bars or fresh patties is comprised between 0.88 and 0.92, the chocolate according to the invention having a fat content comprised between 30 and 38% by weight based on the total weight of the chocolate, advantageously between 32 and 38% by weight based on the total weight of the chocolate, in an advantageous way between 35 and 38% by weight based on the total weight of the chocolate, and further containing at least one non-water-soluble coloring agent, such as for example cochineal red E120.

The present invention further relates to the use of the chocolate according to the invention in contact with a humid food medium having an Aw larger than 0.88, characterized in that the chocolate according to the invention further contains at least one coloring agent, advantageously non-water-soluble, and that its fat content is comprised between 32 and 50% by weight based on the total weight of the chocolate, advantageously between 32 and 45% by weight based on the total weight of the chocolate, in an advantageous way between 32 and 38% by weight based on the total weight of the chocolate, still more advantageously between 35 and 38% by weight based on the total weight of the chocolate.

The present invention finally relates to the use of the chocolate according to the invention in contact with a humid food medium, the Aw of which is less than or equal to 0.88, advantageously less than or equal to 0.85, characterized in that the chocolate according to the invention has a fat content comprised between 28 and 38% by weight based on the total weight of the chocolate, advantageously between 30 and 35% by weight based on the total weight of the chocolate, in an advantageous way between 30 and 33% by weight based on the total weight of the chocolate. Advantageously, in this case, the chocolate or the like does not contain any artificial coloring agent.

The following examples illustrate the invention and in particular the preparation methods and the uses of the chocolate according to the invention.

### EXAMPLE 1

### Bottoming of Biscuits with a Strawberry White Chocolate Analog According to the Invention

A strawberry white chocolate analog according to the invention is made with ingredients grouped together in the following Table 1:

TABLE 1
List of the ingredients and proportions (weight %)

| Ingredients | % |
|---|---|
| Cocoa butter | 27.0 |
| AMF | 3.5 |
| Lecithin | 0.3 |
| PGPR | QS |
| Saccharose | 30 |
| Non-gelatinized native | 14 |
| wheat starch containing | |
| 13% of water | |
| Skimmed milk powder | 20.0 |
| Freeze-dried strawberries | 5.15 |
| with 1.5% water | |
| Vanillin powder | 0.05 |
| Total | 100 |

Nutritional analysis:
FM: 31.0% (excluding PGPR)
Sugaring agents: 43.6%
Including added sugars (not included in the non-refined ingredients, like fruit and milk): 30%
Dry starch: 12.2%
Fruit equivalent: ˜50%
Dairy derivatives as a powder: 20.0%

The method for making this analog of the chocolate according to the invention is standard:
grinding to 33 μm (measured with a micrometer gauge of brand Tesa, reference Tesamaster 03.10001, Switzerland) on a cylinder grinder (standard for the chocolate-maker), in the presence of a portion of lecithin and a portion of FM
and then short conching at less than 45° C. for preserving the flavor of strawberries. Storage at 37° C. Addition of the balance of FM and emulsifiers at the beginning, during and/or at the end of the conching depending on the nature of the conching equipment used (standard for the chocolate-maker).
the chocolate-maker may adapt the yield stress by adding PGPR (0-0.35%).

This analog of the chocolate is tempered and then used as a substitute for chocolate in bottomed biscuits (1 face covered with chocolate, the other one free), such as the standard Pépito (non-molded) from Lu. This method is very standard for the biscuit-maker.

### EXAMPLE 2

### Biscuit With a Shell Molded with Raspberry White Chocolate According to the Invention

The raspberry white chocolate according to the invention is made with ingredients grouped together in the following Table 2:

TABLE 2
List of the ingredients and proportions (weight %)

| Ingredients | % |
|---|---|
| Cocoa butter | 29.8 |
| AMF | 3.0 |
| Lecithin | 0.35 |
| PGPR (indicative) | 0.15 |
| Saccharose | 34.5 |
| Lactoserum powder (11% of | 5 |
| proteins) | |
| Non-gelatinized native | 0 |
| wheat starch containing | |
| 13% of water | |
| Skimmed milk powder | 22.0 |
| Freeze-dried raspberries | 5.15 |
| with 1.5% of water | |
| Vanillin powder | 0.05 |
| Total | 100 |

Nutritional analysis:
FM: 33.5%
Sugaring agents: 51.8%
Including added sugars (not included in the non-refined ingredients, like fruit and milk) 34.5%
Dry starch: 0%
Fruit equivalent: ˜30%
Dairy derivatives as a powder: 27.0%

The method for making this chocolate according to the invention is standard: grinding to 30 μm (measured with a micrometer gauge) on a cylinder grinder in the presence of a portion of the lecithin and a portion of the FM (standard for the chocolate-maker), with short conching at less than 45° C. for preserving the fruit flavor. Storage at 37° C. The chocolate-maker will adapt the yield stress to the needs of the molding method by adapting the PGPR level (0-0.5%).

This chocolate according to the invention is used as a substitute for standard chocolate in biscuits of the Pims type: tempering, and then molding a round shell of chocolate on a molder Frozen Cone (Aasted, DK-3520 Farum); cooling and then filling the shell with a jam, heating up the chocolate edges, depositing a round sponge cake and final cooling. The sponge cake is then stuck to the chocolate shell and confines the jam filling.

### EXAMPLE 3

### Coating Dry Fruit with a Fruit and Yogurt Containing Chocolate Analog According to the Invention

The analog of white chocolate with strawberry and yogurt according to the invention is made with the ingredients grouped together in the following Table 3:

TABLE 3
List of the ingredients and proportions (weight %)

| Ingredients | % |
|---|---|
| Cocoa butter | 25.5 |
| AMF | 3.5 |
| Lecithin | 0.35 |
| Saccharose | 25 |
| Non-gelatinized native | 18.95 |
| wheat starch containing | |
| 13% of water | |
| Skimmed yogurt powder | 21.5 |
| (0.5% FM) containing | |
| living ferments: 5^{E}8 ufc/g | |
| Freeze-dried strawberries | 5.15 |
| with 1.5% water | |
| Vanillin powder | 0.05 |
| Total | 100 |

Nutritional analysis:
FM: 29.65%
Sugaring agents: 41.34%
Including added sugars (not included in the non-refined ingredients, like fruit and milk): 25%
Dry starch: 16.5%
Fruit equivalent: 50%
Dairy derivatives as a powder: 21.5%

The method for making this analog of the chocolate according to the invention is standard: grinding to 35 μm (measured with the micrometer gauge) on a cylinder grinder in the presence of a portion of the lecithin and of a portion of the FM (standard for the chocolate-maker), with short conching at less than 45° C. for preserving the flavor of strawberries, Storage at 37° C.

Dry raisin beads (Aw 0.58) are made from crushed dry raisins.

These beads are coated with 40% of the white chocolate analog according to the invention made above, without tempering (a sugar-coating method for chocolate, well-known to the confectioner—chocolate-maker). The products then keep for 1 month at +4° C. while keeping more than 10^{E}7 ufc/g of living ferments.

### EXAMPLE 4

### Chocolate Compound with Milk and Fruit for a Fresh Bar with Aw 0.90

The analog of strawberry white chocolate (compound) according to the invention is made with the ingredients grouped together in the following Table 4:

TABLE 4
List of the ingredients and proportions (weight %)

| Ingredients | % |
|---|---|
| Hydrogenated coconut oil | 38 |
| 30-32° C. | |
| Lecithin | 0.35 |
| Saccharose | 15.5 |
| Non-gelatinized native | 14.18 |
| wheat starch containing | |
| 13% of water | |
| Skimmed milk powder | 21 |
| Freeze-dried strawberries | 5.15 |
| with 1.5% water | |
| Cochineal red coloring | 0.02 |
| agent E120 | |
| Tri-calcium citrate | 5.8 |
| tetrahydrate CASZ 5785- | |
| 44-4 | |
| Total | 100 |

Nutritional analysis:
FM: 38.55%
Sugaring agents: 29.6%
Including added sugars (not included in the non-refined ingredients, like fruit and milk): 15.5%
Dry starch: 12.3%
Fruit equivalent: 50%
Dairy derivatives as a powder: 21%
Calcium: 1.5% (i.e. 12.5 times more than milk)

The method for making this analog of the chocolate according to the invention is standard: grinding to 35 μm (measured with a micrometer gauge) on a cylinder grinder in the presence of a portion of the lecithin and a portion of the FM (standard for the chocolate-maker) with short conching at less than 45° C. for preserving the strawberry flavor. The balance of FM and lecithin is added at the end of the conching, and the product is then stored at 38° C.

The filling is prepared in three steps:

1. Preparation of a Yogurt

The proportions and ingredients are grouped together in the following table 5:

TABLE 5
List of the ingredients and proportions (weight %)
of the yogurt preparation

| | |
|---|---|
| Skimmed milk | 51-51.5% |
| 40% fat cream | 29-31% |
| Milk protein concentrate NZMP4861 | 7-8% |
| (Fronterra) | |
| Lactose | 11-12% |
| Lactic ferments (for example of the | 0.03% |
| ferment 542 011 (CHR Hansen) type) | |

Re-hydration of the formula is accomplished at 40° C. so that the lactose is properly dissolved.

Method for making the yogurt:
1—pasteurization at 95° C. for 6 minutes and homogenization at 200 bars;
2—fermentation until a pH of 4.8 is obtained
3—smoothing with a dynamic smoother IKA® LABO-PILOT 2000/4 (Werke-Gmbh & Co.KG) consisting of one stage with 3 crowns at 4,000 rpm, in order to obtain a smooth grain-less bright texture;
4—cooling to 4° C.

The thereby obtained yogurt has the following characteristics: 36.5% of dry extract, 12% of fat, and 8.4% of proteins.

2. Preparation of a Combination of Powders

A premix of the powders is made, for which the proportions are indicated in the following table 6:

TABLE 6
list of the ingredients and proportions
(weight %) of the powder premix

| Ingredients | Origin | % |
|---|---|---|
| Dehydrated glucose syrup | Cerestar | 34 |
| C*Sperse01934 | | |
| M/A yogurt powder pH 5.4 | Dr. Suwelack | 29 |
| Liquid glucose syrup | Cerestar | 20 |
| C*SweetM01656 | | |
| Yogurt powder A pH 4.3 | Dr. Suwelack | 10 |
| Amylosed icing sugar | | 6.5 |
| Yogurt flavor 630455H | Givaudan | 0.5 |

3. Preparation of the Fermented Dairy Product Ready to be Included in the Bar:

A 50/50 mixture of the yogurt and of the combination of powders is made with a planetary beater, at maximum speed, for 20 minutes, under cold conditions.

The obtained dairy product has an activity of the water (Aw) at 20° C. of 0.9±0.01 measured with an Aw-meter AquaLab® (Decagon Devices, Inc.), and a pH of 4.8±0.05; it comprises for 100 g: 10.9 g of proteins, 6.2 g of fat, 47.6 g of carbohydrates and 327 mg of calcium and an energy value of 290 kcal/100 g. It contains >10⁸ living ferments/g.

The fresh bar is made in the following way:

1. After cooling to 38° C., the chocolate analog according to the invention made above is molded (by Frozen Cone Aasted) in a bar-shaped hollow shell, which is cooled to 10° C. The thickness of the chocolate analog is 1.3 mm.

2. Depositing the filling at 10° C. and tapping for flattening the surface.

3. Depositing immediately the heel in chocolate analog according to the invention. Final cooling and storage at 4° C.

The chocolate analog accounts for 35% of the weight of the bar which weighs 30 g.

Evaluation at the Use-by Date (Recommended Last Consumption Date):

The product is kept for 4 weeks in the refrigerator: the chocolate analog according to the invention keeps a normal aspect, without any discoloration and with a normal texture.

There is no apparent development of the alteration flora (notably yeasts/fungi) and the filling ferments are still alive (>10⁸ ufc/g for the sum of s. thermophilus and l. bulgaricus).

### EXAMPLE 5

### Milk and Fruit-Containing Chocolate Compound for a Fresh Bar with Aw 0.86

The strawberry white chocolate analog (compound) according to the invention is made with the ingredients grouped together in the following Table 7:

TABLE 7
List of the ingredients and proportions (weight %)

| Ingredients | % |
|---|---|
| Hydrogenated coconut oil | 37.3 |
| 30-32° C. | |
| Lecithin | 0.35 |
| Saccharose | 15.5 |
| Non-gelatinized native | 15.85 |
| wheat starch containing | |
| 13% of water | |
| Skimmed milk powder | 18.0 |
| Freeze-dried strawberries | 10.0 |
| with 1.5% water | |
| Calcium carbonate | 3 |
| Total | 100 |

The composition is close to that of Example 4, but 10% of strawberry powder are used and there is no coloring agent.

Nutritional analysis:
FM: 38.0%
Sugaring agents: 30.7%
Including added sugars (not included in the non-refined ingredients, like fruit and milk): 15.5%
Dry starch: 13.8%
Fruit equivalent: about 100%
Dairy derivatives as a powder: 18%

The method for making the analog is identical with that of Example 4. The filling is prepared in 3 steps:

1. Preparation of a Yogurt (Identical with that of Example 4):

The proportions and ingredients are grouped together in the following table 8:

TABLE 8
List of the ingredients and proportions (weight %)
of the yogurt preparation

| | |
|---|---|
| Skimmed milk | 51-51.5% |
| 40% fat cream | 29-31% |
| Milk protein concentrate NZMP4861 | 7-8% |
| (Fronterra) | |
| Lactose | 11-12% |
| Lactic ferments (for example of the | 0.03% |
| 542 011 (CHR Hansen) ferment type) | |

Re-hydration of the formula is accomplished at 40° C. in order to properly dissolve the lactose

### Method for Making the Yogurt:

1—pasteurization at 95° C. for 6 minutes and homogenization at 200 bars;

2—fermentation until a pH of 4.8 is obtained;

3—smoothing with a dynamic smoother IKA® LABO-PILOT 2000/4 (Werke-GmbH & Co. KG) consisting of a stage with 3 crowns at 4,000 rpm, in order to obtain a smooth grainless and bright structure;

4—cooling to 4° C.

The thereby obtained yogurt has the following characteristics: 36.5% of dry extract, 12% of fat, 8.4% of proteins.

2. Preparation of a Combination of Powders

A premix of the powders is made for which the proportions are indicated in the following table 9:

TABLE 9
List of the ingredients and proportions (weight %)
of the powder premix

| Ingredient | Origin | % |
|---|---|---|
| Dehydrated glucose syrup | Cerestar | 46.68 |
| C*Sperse01934 | | |
| Yogurt powder M/A pH 5.4 | Dr. Suwelack | 25 |
| Liquid glucose syrup | Cerestar | 16.68 |
| C*SweetM01656 | | |
| Yogurt powder A pH 4.3 | Dr. Suwelack | 8.34 |
| Amylosed icing sugar | | 3.3 |
| Total | | 100 |

3. Preparation of the Fermented Dairy Product Ready to be Included in the Bar:

A 40/60 mixture of the yogurt and of the combination of powders is made with a planetary beater at maximum speed, for 20 minutes under cold conditions.

The obtained dairy product has a water activity (Aw) of 0.86±0.01 measured at 20° C. with an Aw-meter Aqualab® (Decagon Devices, Inc.), and a pH of 4.8±0.05;

The Fresh Bar is Made in the Following Way (In a Way Identical with Example 4):

1. After cooling to 38° C., the chocolate analog according to the invention made above is molded (by Frozen Cone Aasted) in a bar-shaped hollow shell, which is cooled to 10° C. The thickness of the chocolate analog is 1.3 mm.

2. Depositing the filling at 10° C. and tapping for flattening the surface.

3. Immediately depositing the heel in chocolate analog according to the invention.

Final cooling to 4° C.

The chocolate analog accounts for 35% of the weight of the bar, which weights 30 g.

### Evaluation at the Use-by Date (Recommended Last Consumption Date):

The product is kept for 4 weeks in the refrigerator: the chocolate analog according to the invention keeps a normal aspect, without discoloration and with a normal texture.

There is no apparent development of alteration flora (notably yeasts/fungi).

1. A fruit-containing chocolate or the like comprising at least one sugaring agent, less than 3% by weight of non-fat dry cocoa, between 24% and 50% by weight of fat, and between 1% and 20% by weight of fruit powder, the fruit powder having a D₉₀ less than 500μm and a water content less than 5% by weight.

2. The fruit-containing chocolate or the like according to claim 1, wherein its Aw is less than 0.60.

3. The fruit-containing chocolate or the like according to claim 1, wherein it further contains between 1% and 40% by weight of dry starch.

4. The fruit-containing chocolate or the like according to claim 1, wherein it further contains milk powder and/or dairy derivative powder at a content from 5% to 40% by weight.

5. The fruit-containing chocolate or the like according to claim 1, wherein the fruit-containing chocolate or the like further contains between 1% and 40% by weight of dry starch and between 5% and 40% by weight of milk powder and/or dairy derivative powder, and wherein the (milk powder+dairy derivatives as a powder+dry starch) content is above 25% by weight.

6. The fruit-containing chocolate or the like according to claim 1, wherein its fat content is from 27% to 45% by weight.

7. The fruit-containing chocolate or the like according to claim 1, wherein its sugaring agent content is from 1% to 55% by weight.

8. The fruit-containing chocolate or the like according to claim 1, wherein it further contains at least one emulsifier.

9. The fruit-containing chocolate or the like according to claim 1, wherein it contains more than 120 mg of elementary calcium for each 100 g of fruit-containing chocolate or the like.

10. The fruit-containing chocolate or the like according to claim 1, wherein the pieces of fruit of the fruit powder are in a freeze-dried form.

11. A method for making the fruit-containing chocolate or the like according to claim 1, comprising:
(a) adding 1% to 20% by weight of fruit powder having a D₉₀ less than 500 μm and a water content less than 5% by weight to the chocolate or the like containing the fat, the sugaring agent, and optionally non-fat dry cocoa;
(b) mixing the fruit powder and chocolate or the like of step (a) at a mixing temperature; and
(c) optionally storing the mixture of step (b) at a storing temperature,
wherein the mixing temperature and storage temperature do not exceed 55° C. for more than 30 minutes.

12. The method according to claim 11, wherein the pieces of fruit of the fruit powder are in a freeze-dried form.

13. A food product selected from the group consisting of biscuit, patty, candy bar, cereal bar, pastry, ice cream, sherbert or the like, fresh patty, and fresh bar, wherein said food product has been totally or partially coated with the fruit-containing chocolate or the like according to claim 1, said fresh patty and said fresh bar containing a filling having an Aw from 0.78 to 0.96.

14. The food product according to claim 13, wherein the filling of the fresh patty and fresh bar contains living ferments.

15. The food product according to claim 13, wherein the Aw of the filling of the fresh bar and fresh patty is from 0.88 to 0.92; and wherein the fruit-containing chocolate or the like has a fat content from 30% to 38% by weight and further contains at least one non-water-soluble coloring agent.

16. A food product comprising the fruit-containing chocolate or the like according to claim 1, in contact with a humid food medium having an Aw larger than 0.88, wherein the fruit-containing chocolate or the like further contains at least one coloring agent, and wherein the fruit-containing chocolate or the like has a fat content from 32% to 50% by weight.

17. The food product according to claim 16, wherein the coloring agent is non-water-soluble.

18. A food product containing the fruit-containing chocolate or the like according to claim 1, in contact with a humid food medium having an Aw less than or equal to 0.88, wherein the fruit-containing chocolate or the like has a fat content from 28% to 38% by weight.

19. The food product according to claim 18, wherein the fruit-containing chocolate or the like does not contain any coloring agent considered as an additive in European legislation.

20. The fruit-containing chocolate or the like according to claim 1, wherein the fruit-containing chocolate or the like comprises less than 1% by weight of non-fat dry cocoa.

21. The fruit-containing chocolate or the like according to claim 2, wherein the Aw is less than 0.35.

22. The fruit-containing chocolate or the like according to claim 3, wherein the content of dry starch is from 13% to 22% by weight.

23. The fruit-containing chocolate or the like according to claim 4, wherein the (milk and/or dairy derivative powder) content is from 15% to 30% by weight.

24. The fruit-containing chocolate or the like according to claim 5, wherein the (milk powder+dairy derivatives as a powder+dry starch) content is above 40% by weight.

25. The fruit-containing chocolate or the like according to claim 6, wherein its fat content is from 27% to 38% by weight.

26. The fruit-containing chocolate or the like according to claim 7, wherein the sugaring agent content is from 20% to 33% by weight.

27. The fruit-containing chocolate or the like according to claim 8, wherein the emulsifier is selected from lecithin, polyglycerol polyricinoleate, and ammonium phosphatide.

28. The fruit-containing chocolate or the like according to claim 9, wherein the elementary calcium is in an amount of more than 400 mg for each 100 g of fruit-containing chocolate or the like.

29. The fruit-containing chocolate or the like according to claim 9, wherein the elementary calcium is in an amount of more than 1,000 mg for each 100 g of fruit-containing chocolate or the like.

30. The method according to claim 11, wherein the mixing and storage temperature do not exceed 45° C. for more than 30 minutes.

31. The food product according to claim 13, wherein the Aw of the filling of the fresh pastry or fresh bar is from 0.8 to 0.93.

32. The food product according to claim 15, wherein the fat content of the fruit-containing chocolate or the like is from 32% to 38% by weight.

33. The food product according to claim 16, wherein the fat content of the fruit-containing chocolate or the like is from 32% to 38% by weight.

34. The food product according to claim 16, wherein the fat content of the fruit-containing chocolate or the like is from 35% to 38% by weight.

35. The food product according to claim 18, wherein the Aw of the humid food medium is less than or equal to 0.85.

36. The food product according to claim 18, wherein the fat content of the fruit-containing chocolate or the like is from 30% to 33% by weight.
